(19) United States
(12) Patent Application Publication
(10) Pub. No.: US 2025/0239962 A1
(43) Pub. Date: Jul. 24, 2025

(54) SUPPORT STRUCTURE FOR AT LEAST ONE SOLAR PANEL

(71) Applicant: ADIWATT, FONTAINE-RAOUL (FR)

(72) Inventor: Paul AZIBERT, PARIS (FR)

(21) Appl. No.: 19/021,486

(22) Filed: Jan. 15, 2025

(30) Foreign Application Priority Data
Jan. 18, 2024 (FR) 2400502

(51) Int. Cl. H02S 20/10

(52) U.S. Cl. CPC H02S 20/10

(57) ABSTRACT

A support structure for at least one solar panel, comprising at least one support post provided with a fastener associated with anchor piles to be driven into soil, wherein the support post extends beyond the fastener, opposite to the at least one solar panel, in order to be driven into the soil. The fastener may comprise a fitting added onto the support post. The fastener may comprise two half-fittings. The two half-fittings may be assembled to each other by one or more of the anchor piles. The support post may extend beyond the fastener, opposite to the at least one solar panel, by at least 50 cm.

### CROSS REFERENCE TO RELATED APPLICATIONS

This application claims priority to FR 2400502, filed on Jan. 18, 2024, the contents of which is hereby incorporated by reference in its entirety.

### TECHNICAL FIELD

The present disclosure relates to the field of bearing structures, and more particularly a support structure for at least one solar panel, for example a photovoltaic or thermal panel. Such a support structure can find its application to support one or more solar panels, in particular in loose soil such as a ground surface or a field.

### BACKGROUND

The support structures for solar panels may comprise one or more posts in order to be fixed to the soil. To anchor the structure relative to the soil, the lower end of the posts is embedded in a concrete base placed on the soil or buried. However, the implementation of such a fixing is heavy, time-consuming and costly.

Lighter systems have been envisaged. For example, utility model DE 20 2020 107 135 U1 provides that each post is fitted onto a foot which is itself placed on the soil and fixed to the soil using piles. Such a system is simpler to implement but may prove insufficient in terms of fixing the posts. Furthermore, the more or less accurate positioning of the foot determines the mounting accuracy of the post and, consequently, the mechanical strength of the support structure.

The invention aims to at least partly overcome these drawbacks.

### SUMMARY

For this purpose, the present disclosure relates to a support structure for at least one solar panel, comprising at least one support post provided with means for anchoring in the soil, the anchoring means comprising a fastener associated with anchor piles to be driven into the soil, in which the support post extends beyond the fastener, opposite to the at least one solar panel, in order to be driven into the soil.

For the sake of brevity, in the present disclosure, and unless otherwise indicated, by “a” or “the” support post (or more simply post), it is meant “at least one” or “the at least one” or even “each” post. In other words, the described properties about a post can apply to any other post of the support structure, where appropriate. The same applies to the anchor piles, or more simply piles.

The support post may be a single piece or composed of several portions assembled together, the post extending generally between an end called upper end, on the solar panel side, and an end called lower end, on the opposite side. On the upper end side, the post may support the solar panel(s) by means of any intermediate support and/or any suitable fixing.

The lower end of the post is intended to be driven into the soil. Thus, in the mounted state, the post extends partially under the surface of the soil and partially above the soil.

The support structure also comprises, for each post, a fastener. Anchor piles, typically at least two piles or even at least three piles, are driven into the soil in order to fix the fastener to the soil. The fastener is itself intended to be secured to the post, whether it is integral with the post or in the form of an insert and fixed to the post.

The fastener may be intended to be located on the soil or above, for example at soil level. Thus, the fastener is located at an intermediate position relative to the post, between the lower end and the upper end. In other words, the support post extends beyond the fastener, not only in the direction of the solar panel (to support said panel in height) but also in the opposite direction, for its driving into the soil.

The soil is preferably a sufficiently loose soil to allow the driving of the post and of the piles, for example an earth soil, sand soil or the like, as opposed to concreted or tarred soils.

The proposed support structure is therefore anchored to the soil not only by the anchoring means but also by the post itself. This results in a more robust fixing and therefore, all other things being equal, better strength of the support structure to mechanical loads, in particular the effect of wind on the solar panels. Conversely, this better fixing of the support structure allows, with equal strength, to lighten the anchoring means, which is advantageous in terms of implementation and costs.

Moreover, the fact that the post is driven into the soil makes it easier to mount the post in the desired position, which improves in fine the mechanical strength of the support structure.

In some embodiments, the fastener comprises a fitting added onto the support post. The fitting can be obtained from a metal sheet, for example by cutting, bending, rolling and/or stamping. Particularly, the position of the fastener on the post can be adjusted directly at the mounting location. This makes it possible to standardize the post and the fastener.

In some embodiments, the fastener comprises two half-fittings. The two half-fittings can be mounted facing each other, on either side of the post. This makes it possible to surround the post without having to slide a part from one end of the post. The mounting is therefore simplified.

The fitting or the two half-fittings may be provided outside the post, which also facilitates their installation.

In some embodiments, the two half-fittings are assembled to each other by one or more of the anchor piles. This makes it possible to secure the half-fittings together without adding an additional part, and ensures good alignment of the half-fittings and therefore better stability of the support structure.

In some embodiments, the support post extends beyond the fastener, opposite to the at least one solar panel, by at least 50 centimeters (cm), preferably at least 1 meter (m). This length may correspond to the depth of driving into the soil. Thanks to these arrangements, the post is solidly anchored in the soil.

In some embodiments, the support post is hollow. This facilitates its driving into the soil insofar as the quantity of material to be driven out during the driving is limited, a fortiori if the lower end of the post is open to the hollow interior of the post. The support post may have a cross section whose contour is open or closed.

In some embodiments, the support post is formed by a profile. Within the meaning of the present disclosure, a profile is an element of constant cross section, with the possible exception of the ends. In these embodiments, at least 50% of the length of the post, or even 75%, has a constant cross section, for example in the intermediate portion of the post. The fact of forming the post by a profile not only facilitates the manufacture of the post but also its driving into the soil.

In some embodiments, the anchor piles are inclined relative to the support post, the angle between an anchor pile and the support post preferably measuring at least 15°, preferably at least 20°, more preferably at least 30°. The angle may be the same between the post and all the anchor piles, or differ from one anchor pile to another. The angle is here a geometric angle, i.e. expressed between 0° and 90°.

Thanks to the fact that the anchor piles are inclined relative to the support post, the piles provide pull-out resistance (tensile force normal to the ground), while the lateral forces on the support structure are supported by the post driven into the soil. Driving the post into the soil therefore allows separating the resistance to the lateral forces from the pull-out resistance, and accurately dimensioning the post and the anchor piles to obtain the desired resistance. This results in better strength and greater design flexibility.

An angle greater than 15° already makes it possible to effectively uncouple the role of the piles from the role of the post. An even greater angle, for example comprised between 20° and 27° or even greater than 30°, for example between 32° and 38°, further accentuates these advantages. The angle between the pile and the post is preferably less than 70°, or even 60°, to guarantee sufficient driving of the pile.

In some embodiments, the anchoring means comprise means for locking the anchor piles relative to the fastener. Thus, after they have been driven into the soil, the piles can be made secured to the fastener. The locking means prevent the withdrawal of the piles from the soil and thus further improve the strength of the support structure.

In some embodiments, the end of the support post opposite to the solar panel is tapered. This facilitates the driving of the post into the soil.

The present disclosure also relates to a method for mounting a support structure for at least one solar panel, the method comprising driving at least one support post of the support structure into the soil, providing means for anchoring said support post, the anchoring means comprising a fastener associated with anchor piles, and driving said anchor piles into the soil. The method can be implemented with a support structure as previously described, and all or part of the characteristics previously described can be applied thereto.

The driving of the support post into the soil may be carried out before, during or after the driving of the anchor piles into the soil. However, the fact of driving the post into the soil, at least partially, before the piles, makes it easier to control the accuracy of the positioning of the post in the soil.

In some embodiments, the mounting method comprises drilling the fastener and/or the support post to accommodate means for fixing the fastener to the support post. The drilling may be carried out directly on the mounting site, preferably after driving the support post into the soil, in order to be carried out exactly at the right place, taking into account any driving difficulties encountered on a particular ground. The mounting is therefore facilitated and the post as well as its fastener can be manufactured in a standard manner, independently of any local stresses.

### BRIEF DESCRIPTION OF THE DRAWINGS

Other characteristics and advantages of the object of the present disclosure will emerge from the following description of embodiments, given as non-limiting examples, with reference to the appended figures.

FIG. 1 is a perspective view of a support structure according to one embodiment.

FIG. 2 is a perspective view of means for anchoring a support post according to one embodiment.

FIG. 3 is a sectional view along plane III-III of FIG. 1.

### DETAILED DESCRIPTION

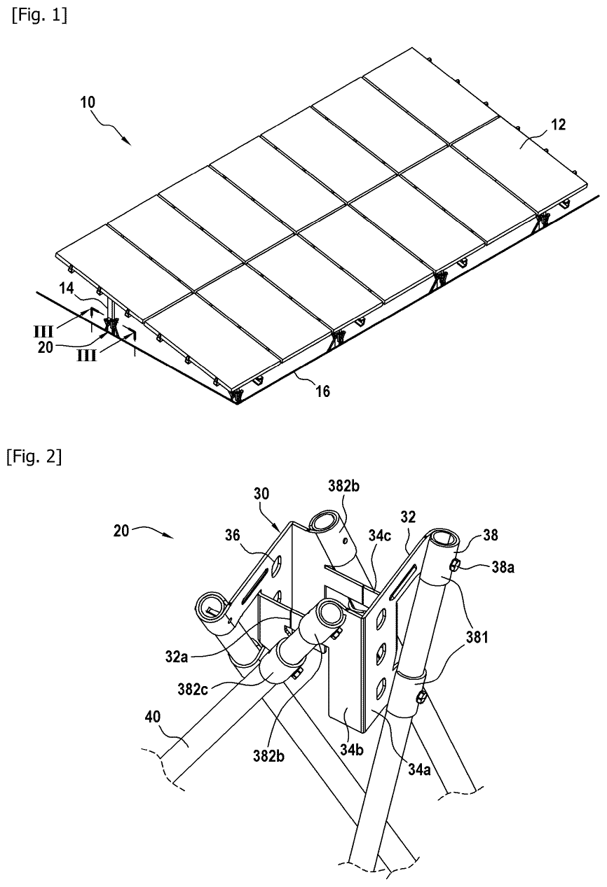

FIG. 1 illustrates in perspective a support structure 10 for at least one solar panel 12 according to one embodiment. The support structure 10 comprises at least one support post 14 (or post 14), in this case a plurality of such posts 14, disposed for example in one or more rows. At their upper end, the posts 14 support one or more solar panels 12, typically photovoltaic or thermal panels, by any suitable means that those skilled in the art would be able to select according to their needs. According to one example, the posts 14 support crosspieces to which mounting rails for the solar panels can be fixed. As illustrated in FIG. 1, the crosspieces or the mounting rails may be inclined relative to the soil 16.

The posts 14 may be identical or different from each other. For example, the posts 14 may be hollow or solid. Alternatively or additionally, each post 14 may be formed by a profile, and have a substantially constant cross-section. For example, as illustrated, the posts 14 may be substantially rectilinear. In the present embodiment, the posts 14 may have an open cross-section, for example in the general shape of a C, U, I or M, but any other open cross-section can be envisaged. Moreover, the cross-section may also be closed, for example in the shape of a polygon (rectangle or the like), a circle or an oval.

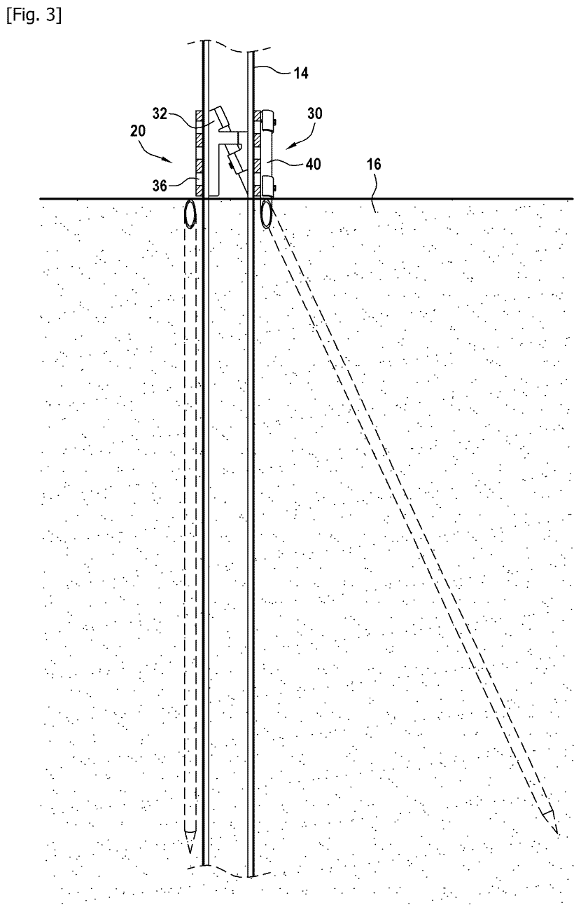

At least some of the support posts 14 are provided with means for anchoring 20 in the soil, one embodiment of which is described below with reference to FIGS. 2 and 3.

In the present embodiment, the anchoring means 20 comprise a fastener 30 associated with anchor piles 40. For better readability, the support post 14 is not represented in FIG. 2, but it is understood from FIG. 3 that the fastener 30 is configured to fit onto the support post 14, outside the support post 14.

The fastener 30 is here an insert on the support post 14. The fastener 30 may comprise a fitting in one or more portions, in this case two half-fittings 32. The half-fittings 32 may or may not be in contact with each other. In this case, they are in contact at complementary edges 32a, which facilitates their correct positioning relative to each other. More generally, the two half-fittings 32 may together define a closed contour that surrounds the post 14, possibly matching its shape (here, a rectangular profile open on one side). The two half-fittings 32 may be disposed on either side of the post 14. The two half-fittings 32 may be identical or different from each other.

The fastener 30, or more specifically each fitting or half-fitting 32, may be made from a cut and folded metal sheet. In this embodiment, each half-fitting 32 comprises a central portion 34a and two flaps on either side of the central portion 34a, namely a first flap 34b and a second flap 34c. The aforementioned edges 32a are located at the interface between the first flap 34b of one half-fitting 32 and the second flap 34c of the other half-fitting 32. The flaps 34b, 34c are here formed at right angles to the central portion 34a, but any other shape can be envisaged to suit the shape of the post 14.

When the fastener 30 is added onto the post 14, it may be provided with means for fixing to the post. For this purpose, at least one of the half-fittings 32 comprises one or more orifices 36, for example, to accommodate such fixing means, for example screws or bolts. In this case, the half-fitting 32 comprises a plurality of orifices 36 arranged in a row, typically two, three orifices or more.

A plurality of anchor piles 40 makes it possible to anchor the fastener 30 into the soil. In this case, four anchor piles 40 are represented, here evenly distributed around the fastener 30, but a different number and/or distribution can be envisaged. The anchor piles 40 are associated with the fastener 30 so as to be inclined relative to the post 14, typically at an angle of at least 15°, preferably at least 20°, more preferably at least 30°, for example approximately 35°.

The means for associating the piles 40 to the fastener 30 may comprise sleeves 38 for receiving said piles 40. Where appropriate, the sleeves 38 may be formed from the same sheet as the half-fitting 32, and therefore be made in one piece with the half-fitting 32. The sleeves 38 may be obtained by rolling. Furthermore, as can be seen from FIG. 2, the anchoring means 20 may comprise means for locking the anchor piles 40 relative to the fastener 30, in particular relative to the sleeves 38, in this case screws 38a which pass through both the sleeves 38 and the piles 40.

Each of the piles 40 may be held by a sleeve 38, or even several sleeves 38 to control its orientation more accurately and distribute the transmission of forces between the fastener 30 and the pile 40. For example, each pile 40 may be inserted into two disjointed sleeves 38. According to one possibility, the two sleeves 38 receiving a given pile 40 may belong to the same half-fitting 32: this is the case of the sleeves 381 in FIG. 2. According to another possibility, the two sleeves receiving a given pile 40 may belong to different half-fittings 32: this is the case of the sleeves 382b, 382c in FIG. 2, the first one 382b belongs to a first half-fitting 32 while the second one 382c belongs to a second half-fitting 32. The first sleeve 382b may be formed on the first flap 34b of a half-fitting 32. The second sleeve 382c may be formed on the second flap 34c of the other half-fitting 32. In this case, the anchor pile 40 secures the two half-fittings 32 therebetween.

This configuration may be made more reliable by the fact that another pile 40 is received symmetrically in a first sleeve 382b of said other half-fitting 32 and in a second sleeve 382c of said one half-fitting 32 (hidden in FIG. 2).

Thus, more generally, the two half-fittings 32 may be assembled to each other by one or more of the anchor piles 40.

As can be seen from FIG. 3, not only the anchor piles 40 but also the support post 14 are to be driven into the soil 16. Thus, the support post 14 extends beyond the fastener 30, opposite to the solar panels it supports. For example, the support post 14 extends beyond the fastener by at least 50 cm, or even at least 1 m, or even at least 1.5 m or 2 m. The more it is possible to drive the support post 14, the more it is possible to lighten the anchoring means 20 that transmit to the post 14 the role of resistance to lateral forces, caused for example by the blowing of the wind on the solar panels. The anchor piles 40 nevertheless retain a role of pull-out resistance.

As illustrated in FIG. 3, the post 14 may extend, opposite to the solar panel, beyond the anchor piles 40. However, the opposite configuration is also envisaged, in which case the anchor piles 40 extend beyond the post 14. Furthermore, although the anchor piles 40 have here been represented with the same length, different lengths may be provided from one pile 40 to another, for example depending on the ability to be driven into the soil 16.

To facilitate its driving into the soil 16, in particular but not only when its lower end (i.e. the end opposite to the solar panel) is solid, the lower end of the post 14 may be tapered. For example, this end may be in the form of a tip or a bevel to better drive out the material from the soil 16 during driving.

The support structure 10 may be installed by driving the support post(s) 14 into the soil and by driving the anchor piles 40, associated with the fastener 30, into the soil. The driving of the post 14 may be done before, simultaneously with or after the driving of the piles 40. For the driving, any suitable tool may be used, for example a hydraulic or pneumatic hammer or another striking means.

According to one exemplary implementation, the post 14 is driven into the soil 16, up to the desired depth or less, but enough to maintain a stable orientation. Then, the half-fittings 32 are disposed around the post 14 and assembled to each other by the piles 40, which are in turn driven into the soil. If necessary, the driving of the post 14 into the soil is then completed. Once the post 14 and the piles 40 have been driven to the desired depth, optionally, any excess length of the post 14 and/or of the piles 40 may be cut, for example chainsawed. The piles 40 are locked relative to the fastener 30, typically via the screws 38a.

In order to fix the fastener 30 to the support post 14, a drilling of the fastener 30 and/or of the support post 14 may be carried out in situ. In the present example, the fastener already comprising the orifices 36, it is the post 14 that is drilled only at the desired location, opposite an orifice 36 for example, to accommodate fixing means. Alternatively, the post 14 could be pre-drilled, in which case the installer may use the drillings of the post 14 which appear facing the orifices 36 to engage the fixing means. Alternatively again, the post 14 may be pre-drilled and the fastener 30 may not be, in which case it is the fastener 30 that is drilled to allow the passage of the fixing means.

Although the present description refers to specific exemplary embodiments, modifications may be made to these examples without departing from the general scope of the invention. For example, although it has been illustrated as an insert on the support post 14, the fastener 30 may be a part of the support post 14, particularly monolithic with the support post 14; in this case, the fastener 30 may be provided at a non-zero distance from the lower end of the post, greater than or equal to the desired driving depth. More generally, individual characteristics of the different embodiments illustrated or mentioned may be combined in additional embodiments. Consequently, the description and the drawings should be considered in an illustrative rather than restrictive sense.

1. A support structure for at least one solar panel, comprising at least one support post provided with a fastener associated with anchor piles to be driven into soil, wherein the support post extends beyond the fastener, opposite to the at least one solar panel, in order to be driven into the soil.

2. The support structure according to claim 1, wherein the fastener comprises a fitting added onto the support post.

3. The support structure according to claim 1, wherein the fastener comprises two half-fittings.

4. The support structure according to claim 3, wherein the two half-fittings are assembled to each other by one or more of the anchor piles.

5. The support structure according to claim 1, wherein the support post extends beyond the fastener, opposite to the at least one solar panel, by at least 50 cm.

6. The support structure according to claim 1, wherein the support post is hollow.

7. The support structure according to claim 1, wherein the support post is formed by a profile.

8. The support structure according to claim 1, wherein the anchor piles are inclined relative to the support post.

9. The support structure according to claim 8, wherein the angle between one of the anchor piles and the support post measures at least 15°.

10. The support structure according to claim 1, further comprising a lock for locking the anchor piles relative to the fastener.

11. The support structure according to claim 1, wherein an end of the support post opposite to the solar panel is tapered.

12. A method for mounting a support structure for at least one solar panel, the method comprising driving at least one support post of the support structure into the soil, providing a fastener associated with anchor piles for anchoring said support post, and driving said anchor piles into the soil.

13. The mounting method according to claim 12, comprising drilling at least one of the fastener and the support post to accommodate a joint for fixing the fastener to the support post.

14. A system comprising a solar panel and a support structure, the support structure comprising at least one support post provided with a fastener associated with anchor piles to be driven into soil, wherein the support post extends beyond the fastener, opposite to the at least one solar panel, in order to be driven into the soil.

15. The system according to claim 14, wherein the fastener comprises a fitting added onto the support post.

16. The system according to claim 14, wherein the fastener comprises two half-fittings.

17. The system according to claim 16, wherein the two half-fittings are assembled to each other by one or more of the anchor piles.

18. The system according to claim 14, wherein the support post extends beyond the fastener, opposite to the at least one solar panel, by at least 50 cm.
